(19) United States
(12) Patent Application Publication
(10) Pub. No.: US 2004/0030039 A1
(43) Pub. Date: Feb. 12, 2004

(54) High molecular weight cationic polymers, preparation method and uses thereof

(76) Inventors: Rene Hund, Saint-Etienne (FR); Cedrick Favero, Saint-Etienne (FR); Pierre Lyot, Saint-Etienne (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/312,599

(22) PCT Filed: Jun. 19, 2001
(86) PCT No.: PCT/FR01/02347

(30) Foreign Application Priority Data
Jul. 27, 2000 (FR) 00/10092

(51) Int. Cl. C08K 3/00

(52) U.S. Cl. 524/800

(57) ABSTRACT

This invention relates to a process for preparation of cationic polymers of high molecular weight based on salts of diallyl dialkyl ammonium, in the form of beads, by the method of reverse suspension polymerization.

This process makes use of a monomer or mixture of monomers of diallyl dialkyl ammonium in a concentration ranging from 67 to 77 percent, preferably from 68 to 72 percent, by weight of active matter.

The process makes it possible to polymerize monomers of this type without development of a specific stabilizing system, without seeded polymerization, even without addition of surfactants to the formulation, without distillation in certain important cases, and avoiding any risk of caking.

The invention also relates to the polymers obtained and their applications in industry, particularly in the papermaking industry, water treatment processes, the mining industry, the cosmetics industry, the textile industry, and generally speaking in all industrial coagulation/flocculation methods.

The invention relates to the technical sector of reverse suspension polymerization, which consists of polymerization of a phase of water-soluble monomers dispersed in the form of droplets in a hydrophobic phase in the presence of stabilizing kinds. Such droplets polymerize as a result of the presence of kinds initiating polymerization (primers) permitting conversion of these drops of liquid to a soft gel made up mostly of water and polymer. The water is then eliminated from the gel by azeotropic distillation to permit separation of a solid phase, polymerized in the form of nodules, from a hydrophobic phase. The nodules are then converted to their final form by final drying thereby permitting elimination of the hydrophobic phase residue.

Specifically, this invention relates to a process of reverse suspension polymerization of cationic polymers of high molecular weight based on diallyl dialkyl ammonium salts. The invention also relates to the polymers obtained and the applications of such polymers in industry.

The invention construes diallyl dialkyl ammonium salts to mean all the compounds of the general formula

(CH2=CH−CH2)₂N⁺R₁R₂,X⁻

in which

X′ is a halide, which may be a bromide, chloride, fluoride, or any counterion with negative charge,

R₁ or R₂ independently represent hydrogen or an alkyl chain containing 1 to 10 kinds of carbon.

The preferred monomer of this invention is diallyl dimethyl ammonium or DADMAC.

### THE PRIOR ART

Processes of synthesis of water-soluble polymer nodules based on ethylene-unsaturated water-soluble monomers have been known since the 1950s. The methods applied and the necessary stabilizing varieties have been described in a large number of patents. The patents DE 1110869, 1959, U.S. Pat. No. 2,982,749, 1961, FR 2383200, 1977, U.S. Pat. No. 4,164,613, 1997, or FR 2360612, 1977, may be cited as examples.

Synthesis of water-soluble polymers based on salts of diallyl dialkyl ammonium was described in papers by Butler relating to polymerization of diallylated compounds in a number of publications between 1949 and 1957 (Butler, J. Am. Chem. Soc.).

These polymers have given rise to many studies because of their chemical structure. One of the main technical problems encountered in industry during polymerization of salts of diallyl dialkyl ammonium is the low reactivity of such salts, this presenting an obstacle to obtaining polymers satisfactorily in solid form and with very high molecular weight. A heavy commercial demand nevertheless exists, and this demand has not been met by the prior art.

In initiating the chief advances made in connection with compounds of this type, the Calgon™ company developed methods allowing optimization of the performance of such polymers during their use. In connection with the coagulation and/or flocculation process, this company in particular recommended that its customers inject polymers of diallyl dialkyl ammonium in powdered form into the suspension to be treated (that is, in the predissolution stage). U.S. Pat. No. 4,654,378 describes the process of producing homopolymers of diallyl dimethyl ammonium in dry form by the UV polymerization technique. The product thus prepared is in the form of freely flowing granules characterized by a very high dissolution rate. A process such as this is nevertheless very difficult to extrapolate from the technical viewpoint for large-scale production.

Use of the polymer DADMAC in the form of solid particles has also been described in several bibliographic references. The following may be cited.

JP 49092855, which describes use of organic coagulants and flocculants in the form of solid particles having a molecular weight ranging from 20,000 to 10,000,000 such as the polyamines, polyDADMACS, the polyethylene imines, the cationic derivatives of polyacrylamice, etc. The polymer is added in the solid state (particle size ranging from 0.01 to 1 mm) directly into the coagulation or flocculation vat. The polymers used for this purpose exhibit a higher efficiency than the conventional addition in solution.

The same coagulation process was subsequently described in JP 60202787; in this process polyDADMAC is used as coagulation agent and was also disclosed in EP 536194.

Among the industrial solutions which may be considered for production in solid form of polymers of diallyl dialkyl ammonium salts, the most promising method is suggested by patent U.S. Pat. No. 4,158,726. This process consists of preparation of nodules of water-soluble polymers on the basis of cationic monomers by reverse-suspension polymerization.

Technical Problem:

However, one of the chief problems encountered by industry in the manufacture of beads of polymers of diallyl dialkyl ammonium salts is due to the significant risk of caking or of formation of aggregates of polymer gels, especially during the stage of azeotropic distillation. This results in loss of all or part of the output.

For this reason synthesis of nodules of polymers of diallyl dialkyl ammonium salts has always been in need of development of the reverse-suspension polymerization method in order to solve these problems.

The following are the developments achieved in the prior art.

EP 0233014 applies the method of seeded polymerization in order to produce stable nodules. This patent shows that it is difficult to produce nodules of poly halides of diallyl dialkyl ammonium directly, since this results in formation of aggregates (example 4 applied to DADMAC). By means of this seeded polymerization method it is then possible to subject the soft gel suspension to azeotropic distillation without the risk of formation of aggregates.

EP 0495312 adds an emulsifier in addition to the polymer stabilizer to the formulation, again in order to prevent the phenomena of aggregation. It finds that, as a matter of fact, polymerization by the standard reverse-suspension processes, that is, with no emulsifier added, leads in the case of DADMAC to a high caking frequency. The molecular weights obtained remain below 3,000,000 for polymerization periods longer than 5 hours.

As for DE 3709921, it develops a specific polymer stabilizer for the purpose of retaining a standard reverse-suspension polymerization process, even for polyDADMAC nodules. Nodules are thus obtained with no aggregate but with a polymerization time of 17 hours, the polymerization being followed by azeotropic distillation; this renders industrial application of this process of little economical viability.

U.S. Pat. No. 4,833,198 uses a specific mixture of polymer stabilizers and inorganic stabilizers to solve the nodule aggregation problems. The field of application of this system of stabilizers includes polyDADMAC nodules, although no specific example is given.

### DESCRIPTION OF INVENTION

It is claimed for the invention that it has surprisingly been found that it is possible to prepare nodules or beads of very high molecular weight of polymers on the basis of a salt, or a mixture of salts, of diallyl dialkyl ammonium by a standard process of reverse-suspension polymerization, use being made of the monomer or mixture of monomers of diallyl dialkyl ammonium salts in a concentration ranging from 67 to 77 percent, and preferably from 68 to 72 percent, by weight of active matter (as a standard, compounds of this type, the most widely used of which is DADMAC, are on the contrary marketed in solution, in concentrations ranging from 62 to 65 percent).

This process does not require development of a specific stabilizing system, or seeded polymerization, or even addition of surfactants to the formulation. The beads or nodules of diallyl dialkyl ammonium salts may thus be produced entirely in accordance with the description of the process disclosed in patent U.S. Pat. No. 4,158,726.

This concentration range surprisingly permits synthesis, as nodules, of polymers of very high molecular weight never before achieved for mononers of this type. For example, the homopolymers of DADMAC obtained by the invention have molecular weights which may easily reach 2.5 million and even as high as 30 million.

In addition, surprisingly, selection of this range of active matter in the form of salts of diallyl dialkyl ammonium also permits reduction of the polymerization time to less than two hours and generally to less than one hour, while the conventional processes describe polymerization times longer than five hours and sometimes reaching 18 hours.

Another aspect of this invention is the effect exerted by the active matter concentration (67-77 percent) in diallyl dialkyl ammonium salts on the texture of the nodules at the end of polymerization. Because of this range of active matter it surprisingly is possible to eliminate the once critical azeotropic distillation stage, since the nodules is already hard; this simplifies the process of synthesis, in fact permitting a substantial saving of time, energy, and investment.

The invention also relates to a process of preparation of water-soluble nodules of branched polymers of diallyl dialkyl ammonium salts of high molecular weight. The requirement for formulation of such branched polymers is that the amount of active matter of the aqueous phase must not be allowed to fall below 67 percent and not to exceed 77 percent by weight. The branching agents which may be used are N-methylol acrylamide, methylene bis acrylamide triethanol amine, and any other multifunction compound capable of effecting branching. Use may also be made of one of the known agents branching diallylated compounds such as methyl triallyl ammonium chloride, triallylamine, tetraallyl ammonium chloride, tetraallyl ethylene diamine, and in general all polyallylated compounds. It is also possible to make post-reticulated polymers as described in the patent WO 00/14124.

Another aspect of the invention relates to possible addition of a polymer to the initial charge in order to make a mixture of polymers in the finished nodule. Since the polymer is dissolved in the aqueous phase prior to dispersion of the latter in the water-repellent phase, and since the polymer may be liquid in form, such polymer may not be compared to that of seeded polymerization, which requires a monomer absorption stage. The polymers which may be used for mixtures with the polymers of diallyl dialkyl ammonium are all water-soluble polymers, and in particular those of the acrylic type and all their known cationic, anionic, and non-ionic copolymers. Organic coagulants such as polyethylene imine, polyvinyl amine, polyamine based on epichlorohydrin, dicyandiamide resin, and melamine formaldehyde, may also be added to the mixture, as may also inorganic polyelectrolytes such as aluminum polychlorides, aluminum sulfates, and the like.

In parallel with the invention it has been found that by keeping the active matter concentration of the aqueous phase between 67 percent and 77 percent it is also possible to eliminate the distillation stage during copolymerization of diallyl dialkyl ammonium halides with any other water-soluble monomer (quaternized, salified or not) susceptible of copolymerizing, for example, methacrylamide and its derivatives, acrylic acid, methacrylic acid,2-acrylamido 2-methyl propane sulfonate (AMPS), dimethyl aminoethyl (meth)acrylate, (meth)acrylamido propyl trimethyl ammonium, N-vinyl pyrrolidone, and the like, and of obtaining water-soluble polymers in the form of nodules over a very wide molecular weight range (10,000 to 30,000,000).

This invention relates more specifically to the processes which have been described and to their embodiments and alternative versions.

The invention also relates to polymers obtained in the form of nodules by these processes and to their applications in industry. Mention may be made as non-restrictive examples of the papermaking industry, treatment of water (drinking water or waste water), coagulation/flocculation methods, the mining industry, the cosmetics industry, the textile industry, etc.

### EXAMPLES

Polymers Pn and Xn were prepared by the method of reverse-suspension polymerization such as that described in patent U.S. Pat. No. 4,158,726.

The polymerization conditions are absolutely identical for these 15 tests, use being made of a known DADMAC primer such as tertiobutyl hydroxy peroxide (TBHP) or V50 (2,2′-azobis[N-(2-hydroxyethyl)-2-methylpropionamidine] dihydrochloride in accordance with patent U.S. Pat. No. 4,158,726.

The active matter content of the suspension may range from 0 to 60 percent, but tests have been conducted which involved use of a formulation with 25 percent active matter.

The Aqueous Phase:

A chelating agent (EDTA (ethylene diamine tetraacetic acid), Versenex™ 80, etc) is added to the aqueous phase, which is then adjusted to pH 4.

Hydrophobic Phase:

The dispersing medium is a water-repellent liquid insoluble in the aqueous phase. For ecologic and toxicologic reasons the tests use an aliphatic hydrocarbon forming an azeotrope with water (for the dehydration of tests X1 and X2).

Dispersion Stabilizer:

The advantage of the present invention lies in the fact that use may be made of the majority of known stabilizers of reverse suspensions (such as those described in patents U.S. Pat. No. 2,982,749, U.S. Pat. No. 4,158,726, GB 1482515, and GB 1329062) with no significant effect on the results observed. Hence the stabilizer may be represented by any polymer stabilizer, but may also be an inorganic stabilizer or a mixture of the two. It is also possible to add a surfactant.

The stabilizer is added to the water-repellent phase in advance of polymerization. Gas is then removed from this phase for 30 minutes in nitrogen during agitation (200 rpm). The aqueous phase is then dispersed and then polymerized. The polymerization periods vary; they are recapitulated in the following table. After polymerization has been completed, the nodules are separated from the water-repellent phase by filtration through a 50 micron filter, with no previous dehydration phase (except for X1 and X2). The residues of the water-repellent phase are cleaned by final oven drying (24 hours at 50° C.). The nodules are spherical with diameters ranging from 50 microns to 1000 microns, with a distribution generally centered around 350 microns. The expert will be able to optimize the polymerization conditions on the basis of his personal knowledge or of simple routine tests. He will also be able to determine the amounts of primers and any addition of additives or transfer agents.

### Example 1

The results obtained by polymerization as nodules as a function of the DADMAC concentration and/or the polymeriztion (Table 1) were compared with those of the polymers in beads described in the prior art (Table 2).

TABLE 1

| | DADMAC | Duration of | |
|---|---|---|---|
| Source | concentration | Polymerization | Molecular Weight |
| X1 | 62% | 1 hour | Caking during dehydration |
| X2 | 62% | 8 hour | Aggregates in course of |
| | | | dehydration, 520,000 |
| P1 | 67% | 45 minutes | 1,610,000 |
| P2 | 67% | 45 minutes | 3,980,000 |
| P3 | 72% | 45 minutes | 3,810,000 |
| P4 | 76% | 45 minutes | 3,450,000 |
| P5 | 67% | 1 hour | 3,230,000 |
| P6 | 69% | 1 hour | 11,170,000 |
| P7 | 72% | 1 hour | 9,400,000 |
| P8 | 76% | 1 hour | 9,090,000 |
| P9 | 67% | 1 hour | 12,650,000 |
| P10 | 69% | 1 hour | >20,000,000 |
| P11 | 72% | 1 hour 45 | >20,000,000 |
| P12 | 76% | 1 hour 45 | 3,450,000 |
| X3 | 85% | 1 hour 45 | Aggregates in course of |
| | | | polymerization 2,160,000 |

TABLE 2

| | DADMAC | Duration of | |
|---|---|---|---|
| Source | Concentration | Polymerization | Molecular Weight |
| DE 3709921 | 60% | 17 hours | << K VALUE >> = |
| | | | 99 → |
| EP 0233014 | 60% | Not specified | IV (intrinsic viscosity) = |
| | | | 0.98 dl/g → |
| | | | 800,000 |
| | 85% | 6 hours | 2,250,000 |
| | 90% | 6 hours | 1,740,000 |
| | 90% | 6 hours | 1,630,000 |
| EP 0495312 | 85% | 6 hours | 2,340,000 |
| | 90% | 6 hours | 2,270,000 |
| | 80% | 6 hours | 1,340,000 |

### Example 2

In place of a homopolymer of DADMAC, a DADMAC acrylamide copolymer 70 molar percent cationic is prepared, use being made of 77-percent DADMAC and a 50-percent commercial acrylamide solution. The concentration of polymerizable material is 70 percent.

The polymerization continues for 45 minutes and the molecular weight of the copolymer nodules is higher than 20,000,000. Addition of a transfer agent of the mercaptoethanol type makes it possible to monitor the molecular weight and thus to limit this weight to 3,560,00 while using the same formulation.

### Example 3

In this example the DADMAC copolymer is branched by 5000 ppm of methyl triallyl ammonium chloride, a DADMAC branching agent extensively described in the literature (J. E. Morgan, M. A. Yorke, J. E. Boothe, Adv. Chem. Ser. (1980), 187 (Ions Polym.), 235-252).

The DADMAC used is at 70 percent. The polymerization takes 1 hour. The molecular weight of the polymer is 7,730,000.

### Example 4

150 grams of 85-percent DADMAC and 32.1 grams of 70-percent polyamine (based on epichlorohydrin) are mixed. The polymerizable matter content of the aqueous phase is 69.6 percent and the active matter content in the suspension is 25 percent. Polymerization continues for 1.5 hours and the mean molecular weight of the mixture is 3,040,000.

It is to be said in conclusion that the various polymers produced by the process claimed for the invention, which illustrates the process without restricting it, exhibit the improvements made at both the level of the polymerization period (<2 hours) and that of the molecular weight values achieved (>2,500,000).

### Example 5

Comparative coagulation-flocculation tests were conducted with a synthetic water. The products made in accordance with the invention were compared with products sold commercially.

For the purpose of making a comparison under similar efficiency conditions of the various polymers, all of the latter were prepared in dilute solutions (the most common form commercially). However, use in dry form is possible and even advantageous. The molecular weight of the polyDADMAC samples used in this study was estimated on the basis the evaluation system disclosed in patent WO 00/09453. While this method yields approximations, it does permit fast comparison the molecular weights of the various products tested.

The “synthetic” water employed in the example was prepared on the basis of tap water to which 0.015 g/l humic acid and 2 g/l kaolin were added.

The tests were conducted in a glass backlit column permitting measurement of a sedimentation time between two marks spaced at an interval of 26 centimeters.

The proportion of polyDADMAC was 6 ppm. The flocculant employed was a 10 percent anionic acrylamide/acrylic acid of high molecular weight marketed by the applicant. The proportion added was 0.5 ppm.

| | Molecular | | | Coagulant | Coagulant + |
|---|---|---|---|---|---|
| Viscosity at 20% | Weight | Source | Form | Only | Flocculant |
| 100 cps | 100,000 | FL 45 | Liquid | 14.9 cm/min | Test not done |
| | | CLV ™ | | | |
| 720 cps | 720,000 | FL 45 | Liquid | 19.0 cm/min | Test not done |
| | | VHM ™ | | | |
| 760 cps | 760,000 | Percol | Nodule | 20.0 cm/min | 24.0 cm/min |
| | | 368 ™ | | | |
| 780 cps | 800,000 | Invention | Nodule | 22.5 cm/min | 25.4 cm/min |
| 11,500 cps | >10,000,000 | Invention | Nodule | 24.0 cm/min | 26.4 cm/min |
| 97,000 cps | >20,000,000 | Invention | Nodule | 27.4 cm/min | 30.6 cm/min |

FL 45 CLV and FL 45 VHM are homopolymers of DADMAC in solution marketed by the SNF™ company.

Percol 368 is a DADMAC homopolymer in the form of nodules marketed by the CIBA SC™ company.

The viscosities are Brookfield™ viscosities measured with the LV 2, 3, or 4 module and at a speed of 60, 30, or 12 revolutions per minute, depending on the polymers.

### Example 6

Dripping tests on papier mâché were performed. The papier mâché was produced in the laboratory by mixing 70 percent paste of broad-leaved trees, 10 percent conifer paste, and 20 percent cellulose (blank dripping value 378 g).

This mixture was then cut with 20-percent calcium carbonate and diluted to 1.5 percent in water. 200 ml of this solution were diluted in 360 ml water. 0.2 percent polyDADMAC and then 0.03 percent of the flocculant of example 5 were added to this solution. The flocculated paste was then brought up to 1 liter in order to conduct a CSF (Canadian Standard Freeness) test.

The final mass dripped thus permits comparison of the dripping properties of the coagulants used. The following results were obtained:

| Product | FL 45 | FL 45 | PERCOL | | | |
|---|---|---|---|---|---|---|
| Name | CLM ™ | VHM ™ | 368 ™ | Invention | Invention | Invention |
| Viscosity at 20% | 100 cps | 720 cps | 760 cps | 780 cps | 11.50 cps | 97,000 cps |
| Mass | 432 g | 428 g | 433 g | 422 g | 451 g | 474 g |
| Dipped | | | | | | |

### Example 7

Comparative coagulation-flocculation tests were conducted with a synthetic water. Several varieties of polyDADMAC in nodule form of different molecular weights were compared.

The artificial or “synthetic” water of the example was prepared on the basis of tap water to which 2 g/l of bentonite were added.

The tests were conducted in a backlit glass column permitting measurement of a period of sedimentation between two marks spaced at an interval of 26 cm.

The amount of polyDADMAC was 6 ppm.

| | | | Sedimentation |
|---|---|---|---|
| Viscosity at 20% | Source | Form | Rate |
| 300 cps | Invention | Nodule | 22.5 cm/min |
| 760 cps | Percol | Nodule | 24.5 cm/min |
| | 368 ™ | | |
| 780 cps | Invention | Nodule | 26.0 cm/min |
| 11,500 cps | Invention | Nodule | 29.2 cm/min |
| 97,000 cps | Invention | Nodule | 36.0 cm/min |

### Example 8

Comparative coagulation-flocculation tests were conducted with waste water from a marble mason's yard (turbidity>1500 NTU). Several varieties of polyDADMAC in nodule form of different molecular weights were compared.

The tests were conducted in a backlit glass column permitting measurement of a period of sedimentation between two marks spaced at an interval of 26 cm. After 10 minutes of decantation, 40 ml of supernatant matter were taken as a sample and the residual turbidity (expressed in NTU, standard turbidity unit) was measured with this sample. The amount of polyDADMAC was 5 ppm.

| Viscosity at | | | Sedimentation | |
|---|---|---|---|---|
| 20% | Source | Form | Rate | Turbidity (NTU) |
| 300 cps | Invention | Nodule | 12.2 cm/min | 12 |
| 760 cps | Percol | Nodule | 16.6 cm/min | 19 |
| | 368 ™ | | | |
| 11,500 cps | Invention | Nodule | 20.0 cm/min | 21 |
| 97,000 cps | Invention | Nodule | 21.0 cm/min | 25 |

### Example 9

Test conducted under the same conditions as those for Example 8.

The polymer used was a mixture of polyDADMAC and polyamine (based on epichlorohydrin and dimethylamine) in the form of nodules, as described on page 7 [of the original] of this application (line 18).

| Viscosity at | | | Sedimentation | |
|---|---|---|---|---|
| 20% | Origin | Form | Rate | Turbidity (NTU) |
| 750 cps | Invention | Nodule | 17.8 cm/min | 7 |

The results of examples 5 to 8 show that, as a result of the process claimed for the invention, increase in the molecular weight of the polymers used permits significant improvement in the performance of these polymers as regards separation and sedimenation rate.

It is also to be noted that the process claimed for the invention also makes it possible to achieve, with equivalent molecular weight, polymers characterized by higher performance than those attained by methods previously disclosed.

This invention also applies to:

polymers and copolymers obtained in the form of nodules by the processes described;

application of the processes described and the polymers and copolymers described in industry, the papermaking industry in particular, water treatment processes (drinking water and waste water), all coagulation/flocculation methods in general, the mining industry, the cosmetics industry, the textile industry, and all similar applications which will be apparent to the expert;

products of the papermaking industry, of water treatment processes (drinking water or waste water), coagulation/flocculation methods, the mining industry, the cosmetics industry, the textile industry, products used for the Bayer™ process (alumina), obtained by application the processes and/or polymers and copolymers claimed for the invention;

and all variations either of application or of the process, or ones relating to the initial monomer or monomers, and in general any modification or adaptation which will be plainly evident to the expert, if necessary after resorting to conduct of several routine tests.

1. A process of producing nodules of polymers of high or very high molecular weight based on a salt or a mixture of salts of diallyl dialkyl ammonium by a process of reverse-suspension polymerization, characterized in that the monomer or mixture of monomers of diallyl dialkyl ammonium salts is used in a concentration ranging from 67 to 77 percent active matter by weight.

2. A process as specified in claim 1, wherein such concentration ranges from 68 to 72 percent active matter by weight.

3. A process as specified in either of claims 1 or 2, wherein the polymerization periods are shortened to less than two hours and generally to less than one hour.

4. A process as specified in any of claims 1 to 3, wherein such process does not require distillation.

5. A process as specified in any of claims 1 to 4, wherein a branching system is added to obtain branched polymers in the form of water-soluble nodules from polymers of salts of diallyl dialkyl ammonium of high molecular weight.

6. A process as specified in claim 5, wherein the branching agents which may be used are N-methylol acrylamide, methylene bis acrylamide, triethanol amine, and any other multifunction compound capable of branching, or one of the known branching agents of diallylated compounds such as methyl triallyl ammonium chloride, triallylamine, tetraallyl ammonium chloride, tetraallyl ethylene diamine, and all polyallylated compounds in general.

7. A process as specified in any of claims 1 to 5, wherein post-cross-linking is effected.

8. A process as specified in any of claims 1 to 7, wherein a polymer is added to the initial charge in order to produce a mixture of polymers in the final nodule, the polymer being dissolved in the aqueous phase in advance of dispersion of the latter in the water-repellent phase, and it being possible for the polymer to be in liquid form.

9. A process as specified in claim 8, wherein the polymers which may be used for mixtures with the polymers of salts of diallyl dialkyl ammonium are all water-soluable polymers and particularly those of the acrylic type and all their known cationic, anionic, and non-ionic copolymers, organic coagulants such as polyethylene imine, polyvinylamine, polyamine based on epichlorohydrin, dicyandiamide resin, melamine formaldehyde resin which may be added to the mixture, as well as inorganic polyelectrolytes such as aluminum polychloride, aluminum chlorides, and aluminum sulfates.

10. A process as specified in any of claims to 9, wherein homopolymerization is effected.

11. A process as specified in any of claims 1 to 10, wherein copolymerization is effected of halides of diallyl dialkyl ammonium with any other water-soluble monomer (quaternized, salified or not) susceptible of copolymerization.

12. A process as specified in any of claims 1 to 11, wherein a homopolymer of DADMAC is prepared.

13. A process as specified in any of claims 1 to 11, wherein an acrylamide/DADMAC copolymer is prepared in a concentration of polymerizable matter of 70 percent, the polymerization lasting less than two hours.

14. A process as specified in claim 13, wherein a transfer agent such as mercaptoethanol is added to the aqueous phase.

15. A process as specified in any of claims 1 to 11, wherein a homopolymer of DADMAC branched by methyl triallyl ammonium chloride is prepared.

16. A process as specified in any of claims 1 to 11, wherein the DADMAC monomer is mixed with a polyamine (based on epichlorohydrin and dimethylamine) in the aqueous phase.

17. A process as specified in any of claims 1 to 11, wherein the homopolymers of DADMAC obtained have molecular weights which may reach 2.5 million and even 30 million.

18. Polymers and copolymers obtained in the form of nodules by the processes specified in any of claims 1 to 17.

19. Application of the processes specified in any of claims 1 to 17 and polymers and copolymers specified in claim 18 in industry, in particular the papermaking industry, water treatment processes (drinking water or wastewater), coagulation/flocculation methods, the mining industry, the cosmetics industry, the textile industry, the Bayer™ process (alumina).

20. Products of the papermaking industry, water treatment processes (drinking water or wastewater), coagulation/flocculation methods, the mining industry, the cosmetics industry, the textile industry, obtained by application of the processes specified in any of claims 1 to 17 and/or polymers and copolymers specified in claim 18.
